(19) United States
(12) Patent Application Publication
(10) Pub. No.: US 2016/0019653 A1
(43) Pub. Date: Jan. 21, 2016

(54) SYSTEM FOR PROVIDING GROUP DISABILITY PROTECTION BENEFITS

(71) Applicant: Hartford fire Insurance Company, Hartford, CT (US)

(72) Inventors: Andrea L. Savastra, Newington, CT (US); Meghan Brooks Pistritto, Rocky Hill, CT (US); Bradley Dean Molinsky, Bloomfield, CT (US)

(21) Appl. No.: 14/336,496

(22) Filed: Jul. 21, 2014

(51) Int. Cl. G06Q 40/08

(52) U.S. Cl. CPC G06Q 40/08

(57) ABSTRACT

According to some embodiments, premium payment information associated with voluntary, group-based disability insurance data may be received from a group server. Moreover, supplemental information associated with the disability insurance data may be received from an external platform. The premium payment information associated with the disability insurance data may be verified to determine that the disability insurance data is valid. The supplemental information associated with the disability insurance data may be evaluated to determine if the supplemental information meets a pre-determined trigger condition. If the disability insurance data is valid and the supplemental information associated with the disability insurance data meets the pre-determined trigger condition, a monetary benefit may be automatically provided to a covered entity associated with the disability insurance data.

### FIELD

The present invention relates to computer systems and more particularly to computer systems that provide group disability protection benefits.

### BACKGROUND

In some cases, a member of a group may have an opportunity to voluntarily purchase a disability insurance policy from an insurer. Moreover, when certain conditions are met the insurer may provide payment to the member when he or she files claims in connection with the disability insurance policy. For example, an employee who becomes too ill to work might receive payments associated with a short term disability insurance policy purchased via an insurance package program available through his or her employer.

It can be difficult, however, to convince some group members to provide premium payments to purchase disability insurance. For example, certain group members may find it hard to envision that they themselves could ever become disabled. As a result, despite the protection that is actually provided by disability insurance, these group members may feel that they personally will not receive any benefit from the policy. It would therefore be desirable to provide systems and methods to provide a monetary benefit to a covered entity of a disability insurance policy in an automated, efficient, and accurate manner.

### SUMMARY

According to some embodiments, systems, methods, apparatus, computer program code and means may provide a monetary benefit to a covered entity associated with disability insurance data. In some embodiments, premium information associated with voluntary, group-based disability insurance data is received from a group server. Moreover, supplemental information associated with the disability insurance data is received from an external platform. The premium information associated the disability insurance data may be verified to determine that the disability insurance data is valid. The supplemental information associated with the disability insurance data may be evaluated to determine if the supplemental information meets a pre-determined trigger condition. If the disability insurance data is valid and the supplemental information associated with the disability insurance data meets the pre-determined trigger condition, a monetary benefit may be automatically provided to a covered entity associated with the disability insurance data.

Some embodiments provide: means for receiving premium information associated with disability insurance policies from an employer server; means for receiving supplemental information associated with the disability insurance policies from an external platform; means for verifying the premium information associated with one of the disability insurance policies in the database to determine that the disability insurance policy is in effect; means for evaluating the supplemental information associated with the disability insurance policies to determine if the supplemental information meets a pre-determined trigger condition; and, if the disability policy is in effect and the supplemental information associated with the disability insurance policy meets the pre-determined trigger condition, means for automatically arranging for a policyholder associated with the disability insurance policy to receive a benefit.

A technical effect of some embodiments of the invention is an improved and computerized method to provide a monetary benefit to a covered entity associated with disability insurance data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 is block diagram of a disability insurance benefit tool or platform according to some embodiments of the present invention.

FIG. 4 is a tabular portion of a disability insurance policy benefit database according to some embodiments.

FIG. 5 illustrates a disability insurance wellness program user interface in accordance with some embodiments.

FIG. 6 illustrates a points-based graphical user interface in accordance with some embodiments.

FIG. 7 is a block diagram of an employer-based wellness program system in accordance with some embodiments.

FIG. 8 illustrates a handheld wellness program user display according to some embodiments.

### DETAILED DESCRIPTION

In some cases, a member of a group may have an opportunity to purchase a “disability insurance policy from an insurer.” As used herein, the phrase “disability insurance” may refer to a form of short or long term disability insurance that insures an employee's earned income against the risk that a disability will prevent him or her from performing core work functions. For example, the inability to lift heavy objects or maintain focus (as with a psychological disorder), an illness, or other conditions may cause physical impairment and an inability to work. Another example of a disability insurance policy is a non-occupational, customizable (e.g., “flexible”) disability insurance policy. According to some embodiments, a premium associated with a disability insurance policy may be based at least in part on information about covered entities, including age, location, industry (e.g., including Standard Industrial Classification (“SIC”) code information), occupation information, gender, etc.

The disability insurance policy may be made available to members of the group on a voluntary basis. As uses herein, the term “group” may refer to employees of an employer, members of a union or trade association, etc. Note that embodiments described herein may be associated with relatively large groups of covered entities (e.g., decisions might be made with respect to tens of thousands of employees). Moreover, the purchase of disability insurance may be “voluntary” such that the member may decide whether or not he or she wants to purchase the policy (e.g., and provide periodic premium payments to the insurer in connection with the policy). Note that in some cases, an entity (such as an employer) may partially fund the disability insurance policy (and an employee might provide additional payments to receive more protection) and/or provide a cafeteria style insurance program wherein group members might pick and choose which types of insurance coverages to purchase. In still other embodiments, a disability insurance program might be self-funded by a group and decisions associated with trigger conditions and/or monetary benefits may be outsourced from the group (e.g., to a disability claim processing platform associated with an insurer). It may be difficult, however, to convince some group members to purchase disability insurance. For example, certain group members may find it hard to envision that they themselves could ever become disabled. As a result, despite the protection that is actually provided by disability insurance, these group members may feel that they personally will not receive any benefit from the policy.

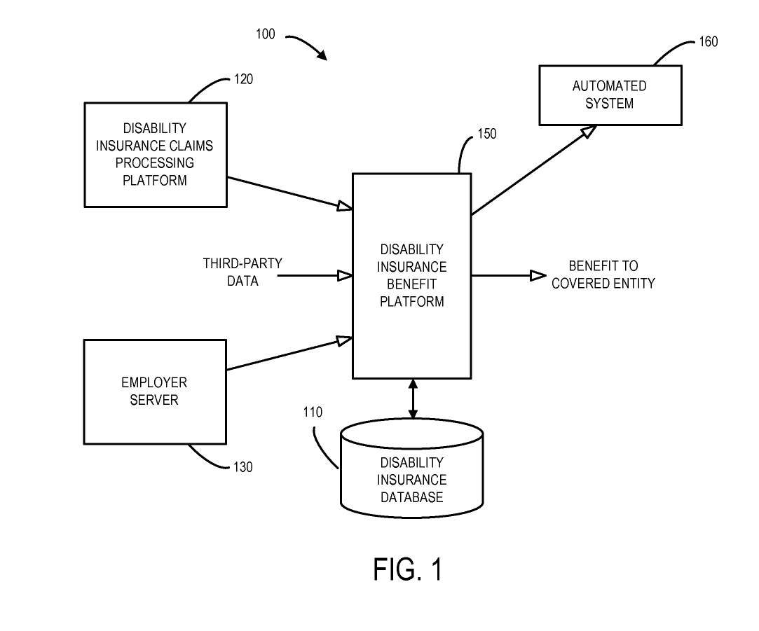

It would therefore be desirable to provide systems and methods to provide a monetary benefit to a covered entity (e.g., a policyholder of a disability insurance policy) in an automated, efficient, and accurate manner. FIG. 1 is block diagram of a system 100 according to some embodiments of the present invention. In particular, the system 100 includes a disability insurance benefit platform 150 that may access a disability insurance database 110 storing information about insurance policies and policyholders. The disability insurance benefit platform 150 may also receive information about disability insurance claims (e.g., by receiving an electronic file from a team leader, an employer, an employee, an insurance agent, or a medical service provider). According to some embodiments, incoming telephone calls and/or documents from a doctor may be used to create information in a disability insurance claim processing platform 120 which, in turn, can provide information to the disability insurance benefit platform 150. The disability insurance benefit platform 150 may also receive information from an employer server 130 (e.g., in connections with premium payments automatically deducted from a policyholder's paycheck) and/or third party data (e.g., from a health club, fitness center, or safety program).

The disability insurance benefit platform 150 might be, for example, associated with a Personal Computers (PC), laptop computer, an enterprise server, a server farm, and/or a database or similar storage devices. The disability insurance benefit platform 150 may, according to some embodiments, be associated with an insurance provider.

According to some embodiments, an “automated” disability insurance benefit platform 150 may facilitate the provision of a monetary benefit to a covered entity. For example, the disability insurance benefit platform 150 may automatically generate and mail a $100 bank check to the policyholder one year after the insurance policy was purchased if the policyholder did not file any disability claims in connection the insurance policy. As used herein, the term “automated” may refer to, for example, actions that can be performed with little (or no) intervention by a human.

As used herein, devices, including those associated with the disability insurance benefit platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The disability insurance benefit platform 150 may store information into and/or retrieve information from the disability insurance policy database 110. The disability insurance policy database 110 might be associated with, for example, an insurance company, an employer, or a type of insurance policy and might also store data associated with past and current disability insurance claims. The disability insurance policy database 110 may be locally stored or reside remote from the insurance claim disability insurance benefit platform 150. As will be described further below, the disability insurance policy database 110 may be used by the disability insurance benefit platform 150 to generate and/or calculate a benefit. According to some embodiments, the disability insurance benefit platform 150 communicates information about the benefit to an automated system 160, such as by transmitting an electronic file to a policyholder device, an insurance agent or analyst platform, an email server, a workflow management system, etc. In other embodiments, the disability insurance benefit platform 150 might output the benefit to a bank account, credit card account, reward program, fitness club server, etc.

Although a single disability insurance benefit platform 150 is shown in FIG. 1, any number of such devices may be included. Moreover, various devices described herein might be combined according to embodiments of the present invention. For example, in some embodiments, the claim disability insurance benefit platform 150 and disability insurance policy database 110 might be co-located and/or may comprise a single apparatus.

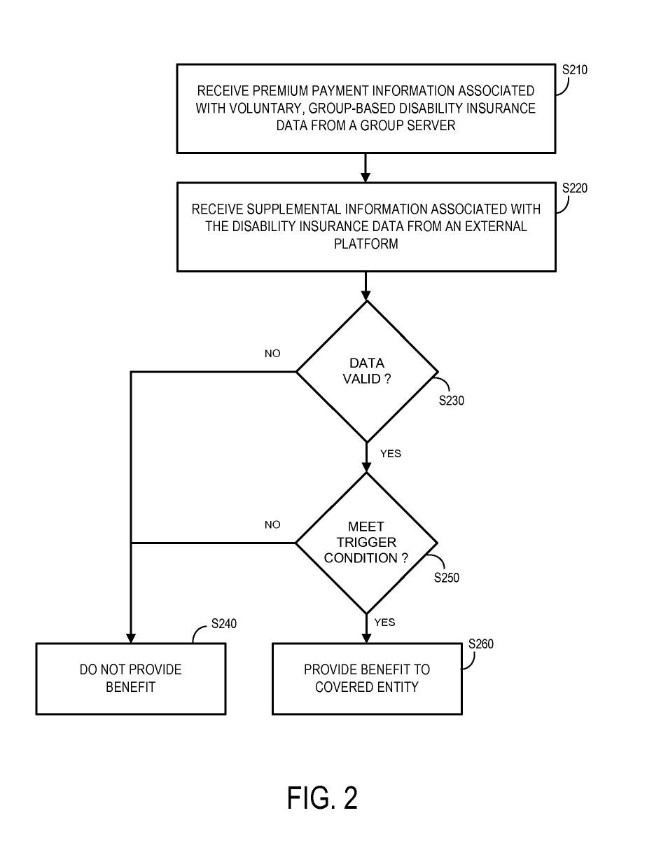

FIG. 2 illustrates a method that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, premium payment information associated with disability insurance data may be received from a group server. In particular, the premium information may be associated with voluntary, group-based disability insurance data. By way of example, the premium information may comprise a batch of electronic records received from an employer server indicating premium payments that have been automatically deducted from thousands of employee paychecks.

At S220, supplemental information associated with the disability insurance data may be received from an external platform. According to some embodiments, the external platform is a disability insurance claims processing platform. In other embodiments, the external platform may be associated with an employer, a health club, a medical institution, an educational service, a safety class, a weight loss program, a stop smoking program, a health monitoring device, and/or an activity monitoring device (e.g., an electronic watch or wristband that wirelessly transmits information to a smartphone or other device).

At S230, the premium payment information associated with the disability insurance data the database may be verified to determine that the disability insurance data is valid. For example, the premium payment information may be verified to ensure that the policyholder has not canceled the disability insurance policy, left the group that he or she was a member of, etc. If it is determined at S230 that the disability insurance data is valid, the process ends at S240 (and, as a result, no benefit is provided to the covered entity).

At S250, the supplemental information associated with the disability insurance data may be evaluated to determine if the supplemental information meets a pre-determined trigger condition. According to some embodiments, the external platform is a disability insurance claims processing platform. In this case, the pre-determined trigger condition may simply be that the policyholder did not file any disability insurance claims during a pre-determined period of time (e.g., during the quarter, the duration of policy, etc.). In other embodiments, the trigger condition may be that the policyholder filed a number of claims (or a total dollar value of claims) that is lower than a threshold value, claims associated with a number of days absent from work lower than a threshold value, etc. If it is determined at S250 that the trigger condition has not been satisfied, the process ends at S240 (and, as a result, no benefit is provided to the covered entity).

Note that, in some embodiments, the trigger condition may be unrelated to the filing of disability claims under the disability insurance policy. For example, the trigger condition might require that the covered entity visit a health club at least once a week for a year or receive physical therapy at a medical institution at least six times during a quarter. Other examples of trigger conditions include requiring the covered entity to attend an event associated with an educational service (e.g., a driving or safety class), participate in a weight loss program, enroll in an online stop-smoking program, maintain a pre-determined health characteristic (e.g., blood sugar level as detected by a health monitoring device), and/or walk a predetermined number of miles per month (e.g., as detected by an activity monitoring device).

Note that decision logic or rules might be implemented such that more than one trigger condition is associated with the disability insurance benefit. For example, in order to receive the benefit a policyholder might need to satisfy three different requirements: (1) he or she must file no disability claims during the past twelve months, (2) he or she must visit a health club at least 50 times during the past twelve months, and (3) he or she must complete an online safety class. As examples, trigger conditions might be associated with a type of disability insurance claim (e.g., back injuries might be associated with different rules as compared to wrist injuries), claim amounts, and/or periods of time (e.g., a worker who returns to a workplace prior to an expected return-to-work date might be associated with a decision rule exception).

If the disability policy insurance data is valid at S230 and the supplemental information associated with the disability insurance data meets the pre-determined trigger condition at S250, a monetary benefit may be automatically provided at S260 to a covered entity associated with the disability insurance data. For example, the providing at S260 may include automatically creating and sending a payment to the policyholder. According to some embodiments, information about the monetary benefit may be automatically transmitted to an email server (e.g., to send an email to the covered entity), a workflow application, a report generator, a social media server (e.g., to post a message to the covered entity's social media account), and/or a calendar application.

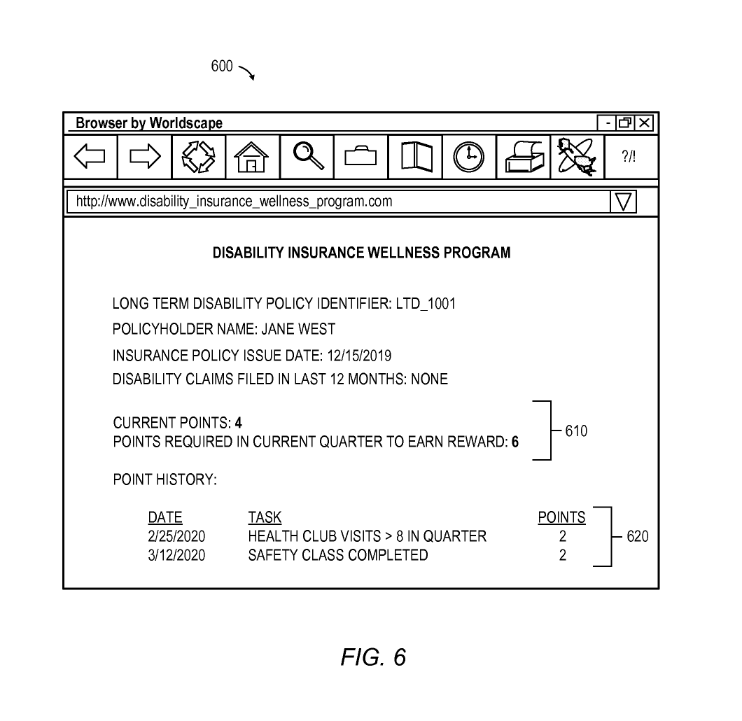

The provided monetary benefit may be a fixed value or percentage of the premium costs. For example, all covered entities might receive a bank check for $50 if they do not file any disability claim during the term of the policy. According to some embodiments, the system may automatically calculate an amount of the monetary benefit for a policyholder. For example, a policyholder might receive $20 for each ten visits to a health club during the term of the disability insurance policy. As described herein with respect to FIG. 6, according to some embodiments a points-based system may be used in connection with a trigger condition and/or an amount of a monetary benefit. As used herein, the term “benefit” may refer to any one or more of a monetary value, an amount of coverage, a level of service, a deductible amount, and/or a period of time.

Note that the method of FIG. 2 might be performed, for example, on a pre-determined date (e.g., on December 31^{st} of each year). According to some embodiments, the method is performed after a pre-determined period of time (e.g. after three months), upon the occurrence of a pre-determined event (e.g., a disability insurance policy is up for renewal), and/or on a periodic basis.

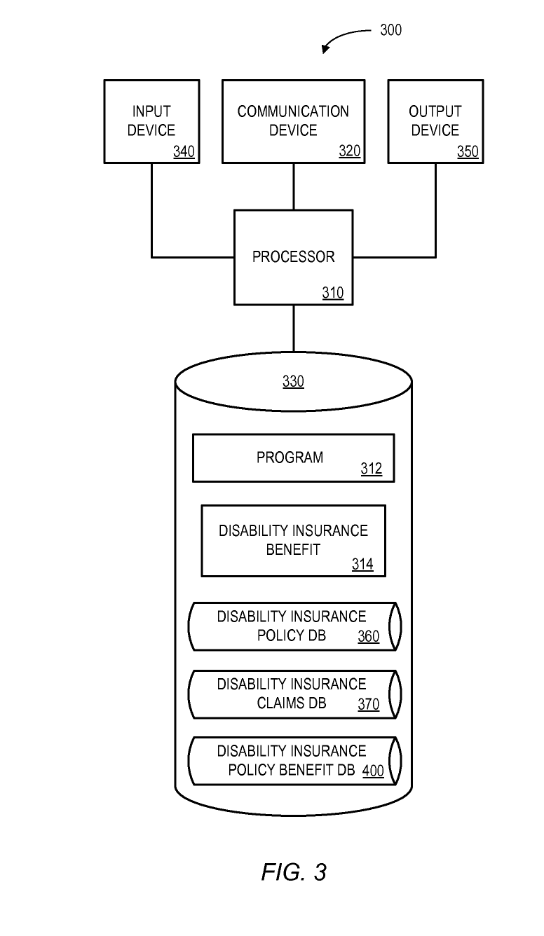

The embodiments described herein may be implemented using any number of different hardware configurations. For example, FIG. 3 illustrates a disability insurance benefit platform 300 that may be, for example, associated with the system 100 of FIG. 1. The disability insurance benefit platform 300 comprises a processor 310, such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more remote team leader and/or claim handler devices. The disability insurance benefit platform 300 further includes an input device 340 (e.g., a mouse and/or keyboard to enter information about trigger conditions) and an output device 350 (e.g., to output a reports regarding benefits that have been provided to policyholders).

The processor 310 also communicates with a storage device 330. The storage device 330 may comprise any appropriate information storage device, including combinations of magnetic storage devices (e.g., a hard disk drive), optical storage devices, mobile telephones, and/or semiconductor memory devices. The storage device 330 stores a program 312 and/or a disability insurance benefit engine or application 314 for controlling the processor 310. The processor 310 performs instructions of the programs 312, 314, and thereby operates in accordance with any of the embodiments described herein. For example, the processor 310 may receive premium information associated with voluntary, group-based disability insurance policies from a group server. Moreover, supplemental information associated with the disability insurance policies may be received by the processor 310 from an external platform. The premium information associated with one of the disability insurance policies may be verified by the processor 310 to determine that the disability insurance policy is in effect. The supplemental information associated with the disability insurance policies may be evaluated by the processor 310 to determine if the supplemental information meets a pre-determined trigger condition. If the disability policy is in effect and the supplemental information associated with the disability insurance policy meets the pre-determined trigger condition, the processor 310 may automatically arrange for a policyholder associated with the disability insurance policy to receive a benefit.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the disability insurance benefit platform 300 from another device; or (ii) a software application or module within the disability insurance benefit platform 300 from another software application, module, or any other source.

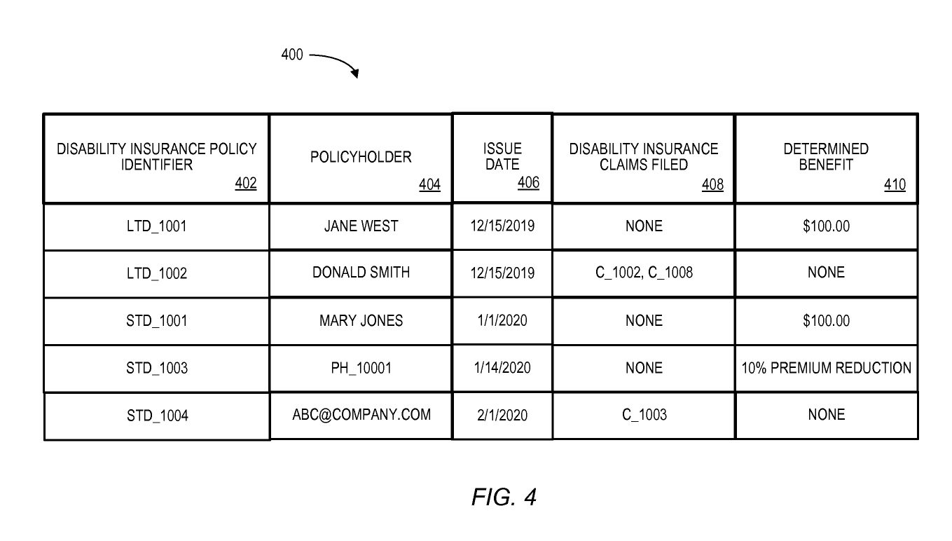

In some embodiments (such as shown in FIG. 3), the storage device 330 further includes a disability insurance policy database (e.g., indicating disability insurance policyholder names, identifiers, dates of issue, etc.), a disability insurance claim database 370 (e.g., indicating claims that have been filed, medical costs, days absent, etc.) and a disability insurance policy benefit database 400. An example of a database that may be used in connection with the disability insurance benefit platform 300 will now be described in detail with respect to FIG. 4. Note that the database described herein is only one example, and additional and/or different information may be stored therein. Moreover, various databases might be split or combined in accordance with any of the embodiments described herein. For example, the disability insurance policy database 360 and disability insurance claims database 370 might be combined and/or linked to each other within the disability insurance benefit application 314.

Referring to FIG. 4, a table is shown that represents the disability insurance benefit database 400 that may be stored at the disability insurance benefit platform 300 according to some embodiments. The table may include, for example, entries identifying insurance benefits that have (or have not) been awarded in connection with a particular disability insurance policy or a number of different policies. The table may also define fields 402, 404, 406, 408, 410 for each of the entries. The fields 402, 404, 406, 408, 410 may, according to some embodiments, specify: a disability insurance policy identifier 402, a policyholder 404, an issue date 406, disability insurance claims filed 408, and a determined benefit 410. The disability insurance benefit database 400 may be created and updated, for example, based on information electrically received and/or manually entered into the system.

The disability insurance policy identifier 402 may be, for example, a unique alphanumeric code identifying a voluntary, group-based insurance policy that has been issued to the policyholder 404 on the issue date 406. The disability insurance claims filed 408 may describe or point to disability insurance claims that were filed in connection with that insurance policy. For example, two claims (“C_{—}1002” and “C_{—}1008”) were filed in connection with long term disability insurance policy “LTD_{—}1002” as illustrated by the second row of the table in FIG. 4.

The determined benefit 410 indicates an amount that was provided to the policyholder 404 as result of a disability insurance wellness rewards program. For example, policyholder “Jane West” did not file any disability insurance claims 408 and, as a result, received a determined benefit 410 of $100. In contrast, policyholder “Donald Smith” filed two disability insurance claims 408 and, as a result, did not receive a determined benefit 410.

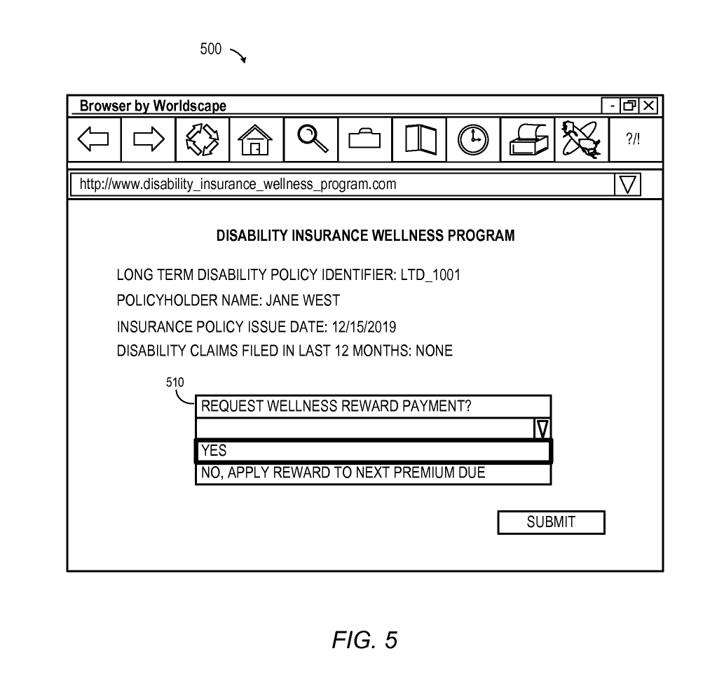

FIG. 5 illustrates a disability insurance wellness program user interface 500 in accordance with some embodiments. The user interface 500 may, for example, be associated with a web page or portal accessed by policyholders. Note that the user interface 500 might be associated with an insurer's web site, an employer web site, a third-party web-site (e.g., a health club web site), etc. The user interface 500 might include information identifying the disability insurance policy, policyholder, etc. According to some embodiments, the user interface 500 includes a user selection area 510 where a policyholder may request to receive a benefit (e.g., by having a bank check mailed to his or her address) or apply the benefit to his or her renewal of the disability insurance policy. Note that in some embodiments, the benefit might be automatically sent to the policyholder (e.g., he or she might not need to proactively request the benefit from the insurer).

According to some embodiments, a disability insurance wellness program may use a points-based system to trigger a benefit and/or to determine an amount of the benefit. For example, FIG. 6 illustrates a points-based graphical user interface 600 in accordance with some embodiments. In this example, a policyholder needs to earn 10 points to receive a wellness program reward. As illustrated by a status area 610 of the user interface 600, the policyholder in FIG. 6 has currently earned 4 points, and, as a result, she needs to earn 6 additional points in order to receive the reward. In this example, policyholders can earn points by performing various tasks. Moreover, a point history 620 area of the user interface 600 may display to the policyholder which tasks have been completed (along with how may points were earned as a result of performing that task). According to some embodiments, a wellness program server may automatically transmit to the policyholder a reminder message (e.g., an email message, social media post, automated telephone message, etc.) including a current amount of points associated with the disability insurance policy and/or a deadline associate with a potential upcoming benefit.

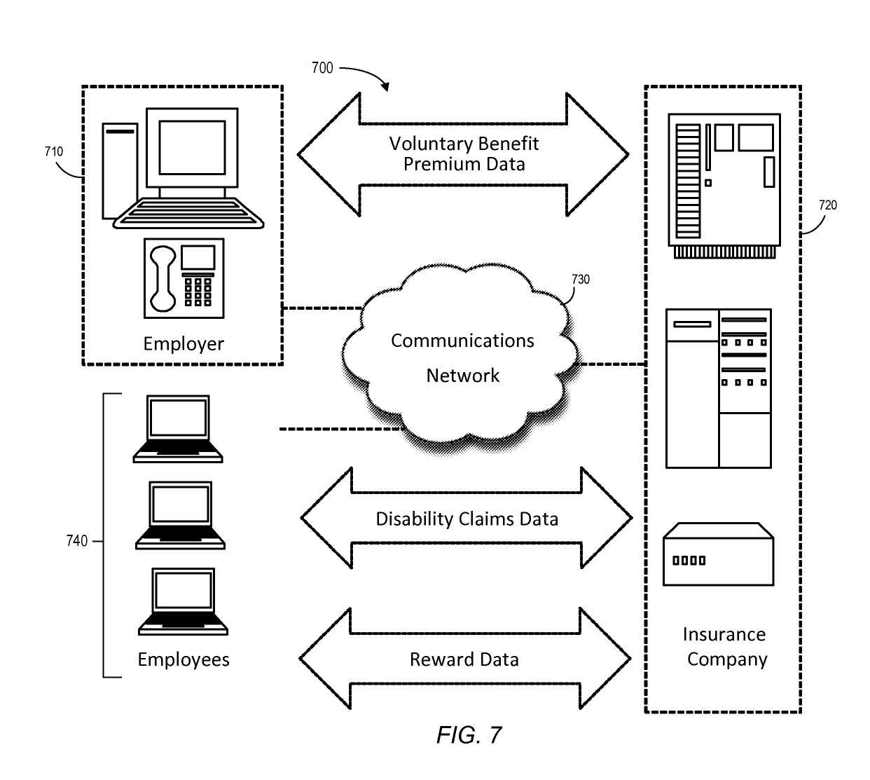

FIG. 7 is a block diagram of multi-entity, employer-based wellness program system 700 in accordance with some embodiments. In particular, employer devices 710 may exchange information with insurance company devices 720 either directly or through a communications network 730. For example, the employer devices 710 may transmit employee census information and/or voluntary benefit premium payment data to the insurance company devices 720. The insurance company devices 720 might use the census information, for example, to automatically calculate a premium value to be associated with a disability insurance program (e.g., based on industry information, one or more employer locations, employee gender, employee age, occupation information, etc.). The premium value may then be transmitted to the employer devices 710. In addition, employee devices 740 may exchange information with the insurance company devices 720 (either directly or via the communication network 730). For example, the employee devices 740 may transmit disability claims data to the insurance company devices 720 (e.g., to report an injury and to request payment under the disability insurance policy). The employee devices 740 may also exchange reward data with the insurance company devices 720. For example, the insurance company devices 720 might transmit an electronic message to an employee device 740 of a covered entity informing the employee that he or she will receive a $100 bank check via postal mail (e.g., because he or she did not file any disability claims during the past twelve months).

Thus, embodiments may provide an automated and efficient way to provide a monetary benefit to a covered entity. Note that a consumer might initially feel that investing in disability insurance is of limited value because he or she does not envision themselves “disabled” and, therefore, mistakenly assume that he or she will never need to use this type of insurance. Some consumers indicate that they feel as if they “don't get anything out of disability insurance” if they don't use it, and are reluctant to provide premium payments. A wellness rewards program in accordance with any of the embodiments described herein may help address this issue by rewarding consumers who have voluntarily purchased disability insurance and who take steps to maintain a healthy lifestyle. With such a program, consumers may feel they are making a sound investment because they are rewarded with tangible dollars back at the end of the year if they do not file a claim. Moreover, embodiments described herein may assist in helping an insurer market voluntary benefits, specifically disability insurance, as a well-worth-it investment because consumers will “get something back” if they do not become disabled for a period of time.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

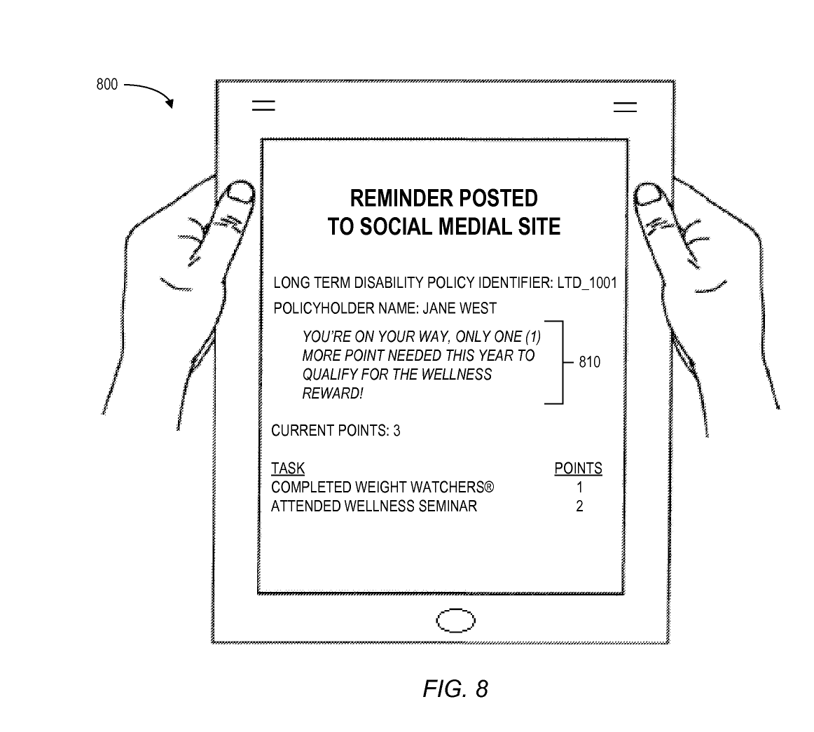

Applicants have discovered that embodiments described herein may be particularly useful in connection with long and short term disability policies. Note, however, that other types of insurance may also be associated with embodiments described herein. Moreover, the displays 500, 600 illustrated with respect to FIGS. 5 and 6 are only provided as examples, and embodiments may be associated with any other types of user interfaces. For example, FIG. 8 illustrates a handheld wellness program user display 800 according to some embodiments. In this particular user display 800, a social media message 810 has been automatically posted to via the policyholder's social media account to remind her that she needs to earn one more point this year in order to qualify for the disability insurance wellness reward.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system associated with voluntary, group-based disability insurance data processing, the system comprising:
a database for receiving, storing and processing voluntary, group-based disability data, including age and industry information;
a communication device to receive: (i) premium payment information associated with the disability insurance data from a group server, and (ii) supplemental information associated with the disability insurance data from an external platform; and
a processor in communication with the database and the communication device, wherein the processor is configured to:
verify the premium payment information associated the disability insurance data in the database to determine that the disability insurance data is valid;
evaluate the supplemental information associated with the disability insurance data to determine if the supplemental information meets a pre-determined trigger condition, and
if the disability insurance data is valid and the supplemental information associated with the disability insurance data meets the pre-determined trigger condition, automatically provide a monetary benefit to a covered entity associated with the disability insurance data.

2. The system of claim 1, wherein the disability insurance data is associated with one of: (i) a long term disability insurance policy, (ii) a short term disability insurance policy, and (iii) a non-occupational, customizable disability insurance policy.

3. The system of claim 1, wherein the disability insurance data is associated with an employer-based insurance package program.

4. The system of claim 3, wherein said providing comprises automatically creating and sending a payment to the covered entity.

5. The system of claim 4, wherein the external platform is a disability insurance claims processing platform and the pre-determined trigger condition is that the covered entity did not file any disability insurance claims during a pre-determined period of time.

6. The system of claim 1, wherein the external platform is a disability insurance claims processing platform and the pre-determined trigger condition is associated with decision logic based on at least one of: (i) a disability insurance claim type, (ii) a disability insurance claim monetary amount, (iii) a number of disability insurance claims, (iv) a period of time, and (v) a plurality of trigger conditions.

7. The system of claim 1, wherein an additional benefit is provided to the covered entity along with the monetary benefit, the additional benefit being associated with one of: (i) an amount of coverage, (ii) a level of service, (iii) a deductible amount, or (iv) a period of time.

8. The system of claim 1, wherein the voluntary, group-based disability insurance data further includes at least one of: (i) gender information, (ii) location information associated with the covered entity, (iii) occupation information, and (iv) standard industrial classification code information.

9. The system of claim 1, wherein the external platform is associated with at least one of: (i) an employer, (ii) a health club, (iii) a medical institution, (iv) an educational service, (v) a safety class, (vi) a weight loss program, (vii) a stop smoking program, (viii) a health monitoring device, and (ix) an activity monitoring device.

10. The system of claim 1, wherein the processor is further to calculate an amount of the monetary benefit.

11. The system of claim 1, wherein the pre-determined trigger condition is associated with a number of points awarded to the covered entity.

12. The system of claim 11, wherein, prior to said evaluating, the processor is to automatically transmit to the covered entity a reminder message including a current amount of points associated with the disability insurance data.

13. The system of claim 9, wherein said evaluating is performed at least one of: (i) on a pre-determined date, (ii) after a pre-determined period of time, (iii) upon the occurrence of a pre-determined event, and (iv) on a periodic basis.

14. The system of claim 1, wherein the processor is further configured to:
automatically transmit information about the monetary benefit to at least one of: (i) an email server, (ii) a workflow application, (iii) a report generator, (iv) a social media server, and (v) a calendar application.

15. A computerized method associated with a voluntary, employer-based disability insurance policy program, the method comprising:
receiving, at a computer processor of a disability insurance benefit platform, premium payment information associated with disability insurance data from an employer server;
receiving, by the computer processor, disability insurance claim information associated with the disability insurance policies from a disability insurance claims processing platform;
verifying, by the computer processor, the premium payment information associated with one of the disability insurance policies, associated with an employee, to determine that the employ has paid the premium for the disability insurance policy;
evaluating the disability insurance claim information to determine if a policyholder associated with the disability insurance policy has filed a disability insurance claim during a pre-determined period of time; and
if the disability insurance premium has been paid and the employee has not filed a disability insurance claim during the pre-determined period of time, automatically creating and sending a payment to the employee.

16. The method of claim 15, wherein the disability insurance policy comprises one of: (i) a long term disability insurance policy, (ii) a short term disability insurance policy, and (iii) a non-occupational, customizable disability insurance policy.

17. The method of claim 15, further comprising:
receiving, at the computer processor, census data from the employer server, including age and industry information associated with employees;
calculating, by the computer processor, a premium value based on the received census data;
transmitting the calculated premium value from the computer processor to the employer server.

18. The method of claim 15, wherein the computer processor is further to calculate an amount of the payment sent to the employee.

19. A non-transitory, computer-readable medium storing instructions adapted to be executed by a computer processor to perform a method associated with voluntary, employer-based disability insurance data, said method comprising:
receiving census data from an employer server, including age and industry information associated with a covered entity;
calculating a premium value based on the received census data;
transmitting the calculated premium value to the employer server;
receiving premium payment information associated with the disability insurance data from the employer server;
receiving supplemental information associated with the disability insurance data from an external platform;
verifying the premium payment information associated with the disability insurance data to determine that the disability insurance data is valid;
evaluating the supplemental information associated with the disability insurance policies to determine if the supplemental information meets a pre-determined trigger condition; and
if the disability insurance data is valid and the supplemental information associated with the disability insurance policy meets the pre-determined trigger condition, automatically providing a monetary benefit to a covered entity device associated with the disability insurance data.

20. The medium of claim 19, wherein the disability insurance policy comprises one of: (i) a long term disability insurance policy, (ii) a short term disability insurance policy, and (iii) a non-occupational, customizable disability insurance policy.

21. The medium of claim 19, wherein said providing comprises automatically creating and sending a payment to the covered entity.

22. The medium of claim 21, wherein the external platform is a disability insurance claims processing platform and the pre-determined trigger condition is that the covered entity did not file any disability insurance claims during a pre-determined period of time.

23. The medium of claim 19, wherein, prior to said evaluating, the processor is to automatically transmit to the covered entity device a reminder message including a current amount of points associated with the disability insurance data.
